(19) United States
(12) Patent Application Publication
(10) Pub. No.: US 2009/0089157 A1
(43) Pub. Date: Apr. 2, 2009

(54) METHOD AND APPARATUS FOR CONTROLLING AN AVATAR'S LANDING ZONE IN A VIRTUAL ENVIRONMENT

(76) Inventor: Rajesh Narayanan, San Jose, CA (US)

Correspondence Address: THORNE & HALAJIAN;APPLIED TECHNOLOGY CENTER, 111 WEST MAIN STREET, BAY SHORE, NY, 11706, US

(21) Appl. No.: 11/862,215

(22) Filed: Sep. 27, 2007

(51) Int. Cl. G06Q 40/00; G06F 17/00; G06F 17/40

(52) U.S. Cl. 705/14; 705/1

(57) ABSTRACT

A system, method and device for providing a landing zone in a virtual environment including accessing a network by providing a user identifier, retrieving a user profile based on the user identifier, determining the landing zone based on the retrieved user profile, and rendering the virtual environment based on the determined landing zone. The method may include initiating rendering of a user avatar at the landing zone. The landing zone may be an advertiser sponsored area within the virtual environment. The landing zone may be related to one or more of advertiser products, objects and trademarks including where those products/objects/trademarks are placed in the virtual environment, including placement with relation to the user avatar. The advertiser related object may be selected based on the retrieved user profile. Rendering the virtual environment may include initiating a login of a user on a server device hosting the virtual environment.

### FIELD OF THE PRESENT SYSTEM

The present system relates to a method and apparatus for controlling a landing zone, such as an avatar's or object's, in a virtual world.

### BACKGROUND OF THE PRESENT SYSTEM

In typical role-playing games (RPGs), users interact within a virtual environment following a set of gaming rules that are established for a given virtual environment, termed a virtual “world”. The user typically accesses a server that is “hosting” the virtual environment via a network, such as a wired and/or wireless network. In accessing the virtual environment, different virtual environments, such as virtual worlds have different login and/or landing zones which are locations within the world wherein a user starts each time that the environment is initiated or after a given point within the virtual experience. Further, transitory objects that are located around the virtual environment typically are initiated in a location termed a “drop-zone”.

For example, in a typical environment, a user may enter the virtual environment at a given starting location (e.g., landing zone), for example when first entering a virtual environment or at a same place in which the environment was last exited. In virtual environments wherein an avatar's life may be terminated, such as in roll playing game, termed RPG (e.g., a first-person shooter) virtual environment, user's typically have one or more designated locations wherein the avatar may spawn after the avatar's life is spent during interaction within the virtual environment. Even in virtual environments wherein multiple worlds are available to a user, the user typically has no options as to what login/landing zone for the avatar other than a selection of the world or realm within the virtual environment.

These virtual environments are typically visually very rich and complex. Often, in the avatar wandering around the virtual environment, different realms may be visited and explored and different objects may be encountered.

Advertisers are looking for ways to extend advertising to these virtual worlds yet a problem exists in that even though there may be many users logged in to the virtual environment at any given time, the number of “eyeballs” that any given portion of the virtual environment gets is limited since the virtual environments are very large. This problem will not go away even if the number of users/avatars logged in increases significantly, such as ten-fold, since typically, the virtual environment (e.g., virtual “land area”) is increased to support the larger number of users. Even if the virtual environment where to support a high population, say a ten (10) fold or a hundred (100) fold increase in user population, this pales in comparison to what is considered as a critical mass to generate significant revenue in terms of eyeballs or Cost per Thousand Impressions (Cost Per Mille or CPMs). CPM constitutes a well known concept in the advertisement industry. Those of ordinary skill in the art recognize the limitations of virtual worlds in accordance with prior systems to generate significant revenue based on CPM within islands/zones/areas of the virtual worlds operating in accordance with prior systems.

It is an object of the present system to overcome disadvantages and/or make improvements in the prior art.

### SUMMARY OF THE PRESENT SYSTEM

The present system includes a system, method and device for providing a landing zone in a virtual environment including accessing a network by providing a user identifier, retrieving a user profile based on the user identifier, determining the landing zone based on the retrieved user profile, and rendering the virtual environment based on the determined landing zone. Rendering the virtual environment may include initiating rendering of a user avatar at the landing zone. The landing zone may be an advertiser sponsored area within the virtual environment. The landing zone may be related to one or more of advertiser products, objects and trademarks including where those products/objects/trademarks are placed in the virtual environment including placement with relation to the user avatar.

Rendering the virtual environment may include initiating rendering of an advertiser related object at the landing zone, wherein the advertiser related object is selected based on the retrieved user profile. Rendering the virtual environment may include initiating a login of a user on a server device hosting the virtual environment. An embodiment of the present system may include verifying authorization for a user corresponding to the user identifier to access the virtual environment.

Verifying authorization for the user may include a service provider receiving compensation from an advertiser for providing the authorization and determined landing zone. An increased compensation may be received for providing a user associated with a user profile wherein elements of the user profile indicate a bias towards the products/objects related to the advertiser and/or a trademark related to the advertiser.

Rendering the virtual environment may include providing login credentials to a client proxy for the virtual environment or providing the login credentials directly to the user. Rendering the virtual environment may include providing streaming content to a user device for rendering. The landing zone may be determined from a plurality of potential landing zones associated with one or more advertisers. The user profile may include at least one of an explicit and implicit user profile.

In an alternate embodiment, a method of receiving advertiser compensation for providing user access to a landing zone within a virtual environment is provided and/or one or more program portions for performing the method are provided. The method may include maintaining a count of users provided to an advertiser's landing zone, providing the count of users to an advertiser related to the advertiser's landing zone, and receiving compensation from the advertiser based on the count. The method may include receiving a user request for access to the virtual environment, and retrieving a profile associated with the user.

In one embodiment, the advertiser's landing zone may be an advertiser sponsored area within the virtual environment. The advertiser's landing zone may be related to one or more of advertiser products, objects and trademarks. The advertiser's landing zone may be a location within the virtual environment wherein an advertiser related object is rendered. The advertiser related object may be selected based on a retrieved user profile. The present method may include verifying authorization for a user corresponding to one of the count of users to access the virtual environment. Verifying authorization for the user may include a service provider receiving compensation from an advertiser for providing the authorization and advertiser's landing zone. The compensation may be increased for a user that is biased towards an advertiser's products and/or trademarks. The compensation may be increased for the time that a user's avatar lingers in an advertiser's area and/or near an advertiser's product/object/trademark.

### BRIEF DESCRIPTION OF THE DRAWINGS

The invention is explained in further detail, and by way of example, with reference to the accompanying drawings wherein:

FIG. 1 shows a system in accordance with an embodiment of the present system;

FIG. 2 shows a process flow diagram in accordance with an embodiment of the present system; and

FIG. 3 shows a portion of a system (e.g., client, server, proxy, etc.) in accordance with an embodiment of the present system.

### DETAILED DESCRIPTION OF THE PRESENT SYSTEM

The following are descriptions of illustrative embodiments that when taken in conjunction with the following drawings will demonstrate the above noted features and advantages, as well as further ones. In the following description, for purposes of explanation rather than limitation, illustrative details are set forth such as architecture, interfaces, techniques, etc. However, it will be apparent to those of ordinary skill in the art that other embodiments that depart from these details would still be understood to be within the scope of the appended claims. Moreover, for the purpose of clarity, detailed descriptions of well known devices, circuits, techniques and methods are omitted so as not to obscure the description of the present system. It should be expressly understood that the drawings are included for illustrative purposes and do not represent the scope of the present system.

For purposes of simplifying a description of the present system, the term rendering and formatives thereof as utilized herein refer to providing content, such as content related to a virtual environment, such that it may be perceived by at least one user sense (e.g., sense of sight and/or a sense of hearing). For example, a rendered virtual world may include audio data, visual data, and/or textual data, etc., that is perceivable by the user, for example via a user rendering device accessing a server that is hosting the virtual environment. Further, although the term “landing zone” is utilized herein as an example of a location wherein the virtual environment may be initiated or reinitiated, this term should be understood to include other similar locations in a given virtual environment, such as a place wherein a character is spawned, respawned, a location where objects are initiated, such as a drop-zone, etc. The term “operatively coupled” and formatives thereof as utilized herein refer to a connection between devices or portions thereof that enables operation in accordance with the present system. For example, an operative coupling may include one or more of a wired connection and/or a wireless connection between two or more devices that enables a one and/or two-way communication path between the devices or portions thereof.

The system and method described herein address problems in prior art systems. In accordance with an embodiment of the present system, a system and method may be provided for controlling a determination of a landing zone in a virtual environment wherein an avatar is initiated. In accordance with a further or alternate embodiment, the location of advertiser relevant objects within the virtual environment may be controlled and initiated (e.g., rendered) in a region related to where the avatar is located, with object selection being determined based on a user profile. For example, the user profile may include one or more of interests, hobbies, shopping decisions, age, gender, location and any data electronic or otherwise that may be either collected directly, such as from the user, or indirectly, such as from third party sources.

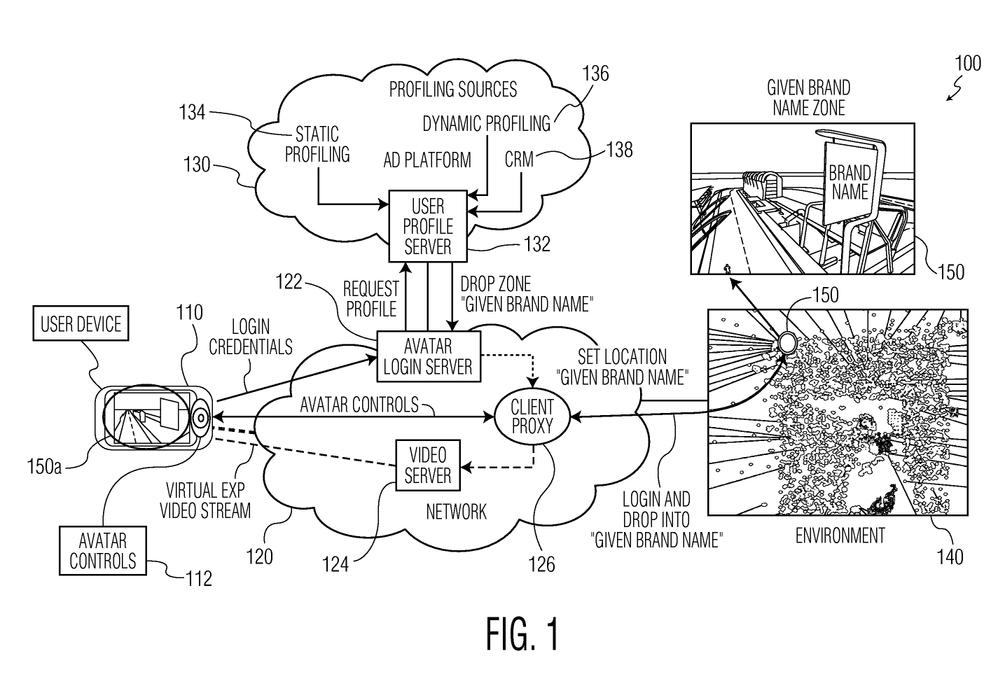

FIG. 1 shows a system 100, one or more portions of which may be utilized for operation in accordance with the present system. The system 100 may include a user device 110 that interacts with a gaming environment 140 via a network 120. The system 100 further includes profiling sources 130 that interact with the network 120 for purposes of affecting a landing zone/object selection, etc., within the virtual environment. The network 120 includes an avatar login server 122 that is operatively coupled to the user device and a client proxy 126 that provides the user device 110 access to the virtual environment 140. The network 120 also includes a video server 124, which may typically host the virtual environment. The video server 124 may be operatively coupled to the client proxy 126 and the user device 110. As may be readily appreciated the video server 124 may include one or more storage devices and processing units for providing the virtual environment 140 to the user device as well as storing elements of the user device 110 unique to a given user device 110 (e.g., interaction elements) and unique to a given user (e.g., user identification information). As may be readily appreciated, elements unique to the user device 110 and the given user may also be stored directly on the user device 110 in accordance with the present system and/or be stored within the network 120, such as on a server accessible through the network 120. In an alternate embodiment, in place of storage on the video server 124, elements unique to the user device 110 and the given user may be stored directly on the user device 110.

The profiling sources 130 includes a user profiling server 132 that may include user/user device profiling sources 130 such as static profiling, dynamic profiling, customer relationship management (CRM) software, etc. For example, the profiling sources 130, as may be readily appreciated by a person of ordinary skill in the art, may include implicit profiling, explicit profiling, and/or combinations thereof to provide a user profile for the given user of the user device 110. The profile may also include user identifying information to associate the profile with one or more given users.

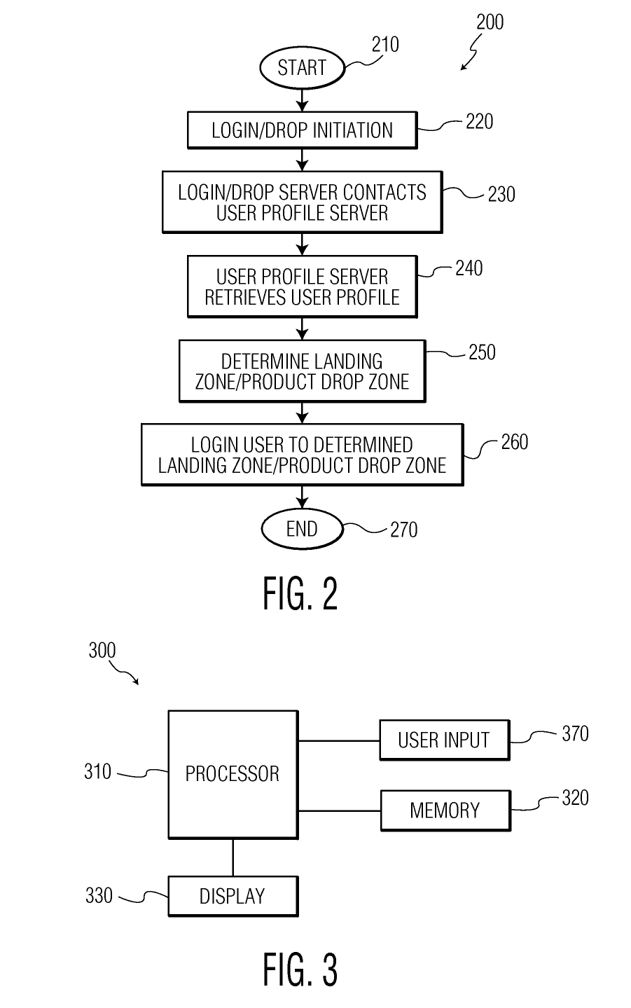

FIG. 2 shows a flow diagram 200 including details of a login/drop initiation process in accordance with an embodiment of the present system. The process begins during act 110 wherein a user activates a user device. Any number of user devices may be suitably employed in accordance with the present system, such as gaming devices (handheld devices, gaming stations, etc.), video players, personal digital assistants (PDAs), set top boxes (STB), cellular phones, etc. The user device may also include a browser based client, like a Java-Applet and/or Flash based program. As may be readily appreciated, in accordance with this embodiment, any device that can support a rendering of content (audio and/or video) transferred from a second party source may be employed as the user device. For example, in one embodiment the second party source need only be a storage device adapted to store a user profile (local and/or remote) and adapted to support the processing acts as described further herein.

During act 220, a user requests a login into a virtual environment. This may occur as a login request to a virtual environment that has never been visited by the user, as a login request to a previously visited virtual environment, as a re-spawning of an avatar that has expired within the virtual environment, and/or may also involve an object and drop-zone of the object. Illustratively, a login request is discussed to simplify the following discussion.

During a login process, a virtual environment client that may be resident on the user device or within the network, contacts a user profiling server via an avatar login server during act 230. The user device provides user identifying information as may be readily appreciated so that the user and avatar persona may be identified/retrieved as well as information identifying a desired virtual environment. In accordance with the present system, the user profile server retrieves a user profile corresponding to the user of the user device during act 240. Based on the user profile, a landing zone for the avatar is determined during act 250. The determined landing zone is transmitted to the login server which communicates with the client proxy to login the user to the determined landing zone within the virtual environment during act 260.

As may be readily appreciated, the proxy mechanism described is only illustrated as one embodiment in accordance with the present system. Alternatively, if the user device, such as a client (device), supports communication and reception of the landing zone from the profiling server, and if the client is capable of rendering the audio and/or visual data related to the virtual world, then the client may directly login the user's avatar utilizing the landing zone as a point of entry into the virtual environment. In another embodiment, the video server may operate as the client proxy. In any event, thereafter, the avatar may be free to wander the virtual environment away from the landing zone if desired and the process ends during act 270. Naturally this process may be reinitiated in response to further triggers (e.g., avatar actions, timing, etc.) within the virtual environment.

In accordance with the present system, by determining a landing zone based on the user profile, an advertiser's landing zone may be assured of receiving a number of viewings by user's, termed “eyeballs”, that are already disposed to be interested in products that may be represented in and around the landing zone. For example, since the landing zone is controlled based on the user's profile, the avatar can be made to land on an island in which a relevant determined brand has a virtual presence. For example, for a user that is profiled to be interested in buying a car, the login zone for the user's avatar may be selected as an island where a given car manufacturer has its presence. As shown in FIG. 1, the login zone is selected as a given brand name landing zone 150 wherein the given car manufacturer has a virtual presence. For example, buildings in the area may bear the manufacturer's trademarks as well as cars, etc. depicted within the virtual area. Through operation of the client proxy, content representing the virtual environment is transferred to the user device 110 for rendering as a rendered environment 150A.

In accordance with the present system, the user profile server utilizes the user profile to determine a suitable landing zone (e.g., starting location) for the user's avatar based on the user's profile. As may be readily appreciated, since virtual environments may represent vast virtual worlds wherein the avatar may wander, for example, at will, it is difficult for advertisers to determine whether product placement within the virtual environment actually receives a reasonable number of viewings to justify the cost. By operation of the present system, given user's that may be predisposed to be interested in a given brand, product, object, class of product/object (e.g., cars as opposed to a given car or brand), etc., may be delivered to an corresponding area wherein the given brand, product, advertiser relevant object, etc. is provided. The advertiser may then fashion this portion of the virtual environment to encourage the user to remain in the area but in any event, at least the advertiser may be assured that some number of users are delivered to view the area.

The present system provides numerous avenues for monetizing a login request to a virtual environment beyond approaches typically available, such as user payments of subscriptions to access the virtual environment. Since a service provider may control landing zones for user avatars, the service provider may charge a fee of an advertiser to deliver “eyeballs” to the advertiser's area. Further, in a case wherein the user, as represented by avatars within the virtual environment, are pre-profiled to have some kind of interest in the services/products offered by the advertiser, the service provider may even charge a higher rate to advertisers than that charged for simply providing an un-profiled user to the advertisers area. In one embodiment, the compensation may be increased for a user that is biased towards an advertiser's products and/or trademarks. The compensation may be increased for time that a user's avatar lingers in an advertiser's area and/or near an advertiser's product/object/trademark.

In this way, a service provider, such as a provider of wired (e.g., cable-based network access) and/or wireless (e.g., cellular telephone, WiFi, etc.) services, need not create a presence or content within these virtual worlds to receive advertising fees. For example, the user profile server (or another operably coupled server) may track a number of user's that are delivered to an advertiser's area and charge the advertiser accordingly (e.g., CPM). In the same or a different embodiment, the client proxy may keep track of the user's avatar location within the virtual environment and the advertiser may also (or in place of) be charged for how long the user avatar remains in the area. Further, the client proxy may track whether related links are selected by the user, all or any portion of which may result in related charges to the advertiser. Users without a profile may receive a default profile and user response to login zones selected may be utilized to begin customizing the default profile to that user.

In accordance with the present system, advertisers may be assured of receiving additional traffic since they get avatars to land directly to their areas. Further, since the users, via their avatars are also profiled to have a particular interest in the services offered by the brand, the brand can more effectively engage the avatar. In this way, virtual worlds may represent a favorable brand-immersion platform. In one embodiment, a user need not even have a subscription or have previously visited a given virtual environment. For example, through the user profile server, a user may be offered free entry into an otherwise pay for use virtual environment. The use-fee may be paid by an advertiser that is delivered the user at a time of login. The advertiser may enable access to the virtual environment for the user, for example for a limited time period or even only within a limited portion of the virtual environment, such as an island controlled by the advertiser. In another embodiment, the user may be enabled to access the virtual environment as long as some time is spent in an advertiser sponsored area, such as periodically. In this scenario, a user benefits in that access to a pay-for-use environment is provided free of any fee to the user. The advertiser benefits in that it is assured of a user that is profiled to have an interest in the advertiser's products and is assured of receiving desired eyeballs. The service provider benefits in that it may receive a fee for providing the user to the login zone. Lastly, the parties running the virtual environment benefit in that they may receive a fee from the advertisers for one or both of the advertisers virtual environment and for providing access of the user's avatar to the virtual environment. Additionally, the party hosting the virtual environment may retain some of these user's as paying user's going forward in an event that the user enjoys the virtual environment and desires to return without being hosted by the advertiser.

In an alternate or additional embodiment, as the avatar wanders through the virtual environment, objects may be provided around the virtual environment beyond the landing zone. These objects are typically provided in a drop-zone in an area around the avatar and are typically determined by the hosts of the virtual environment, such as by a scripted “storyline”. For example, in a role-player game (RPG) virtual environment, the user's avatar may come across objects that are related to the storyline. In accordance with the present system, the objects may be tailored by the user profile server to be relevant to interests of the user. For example, a given storyline may call for the avatar to progress from area A to area B. Objects and designations of objects (e.g., trademarks on objects) within the areas and/or along the way may be determined in accordance with the present system. Further, the storyline may have multiple paths for arriving at the area B with a given one or more of those paths being made available based on the user profile. For example, a user may be profiled to be interested in making a cell-phone purchase. Based on this profile, a cell-phone bearing an advertiser's trademark may be provided within a drop-zone in a vicinity of the user. The cell-phone may in effect, open up a path within the virtual environment for the avatar to proceed to the area B. Other elements of the user profile may provide for an opportunity for further product placement and/or storyline selection. For example, the avatar may utilize the cell-phone to call a friend to “pick them up”. Features of the cell-phone may be driven by advertiser relevant features, such as form, function, etc. The “friend” may arrive in an automobile bearing a trademark of an automobile manufacturer that the user is profiled to have some interest in or some other object/advertiser significant variation.

The present system or portions thereof may be a portion of a client and/or server as described herein. One or more such portions may be resident within the system for operation as described herein.

FIG. 3 shows a portion of a system 300 (e.g., client, server, proxy, etc.) in accordance with an embodiment of the present system. For example, a portion of the present system may include a processor 310 operationally coupled to a memory 320, a display 330 and a user input device 370, such as avatar controls 112 of the user device 110 depicted in FIG. 1. The memory 320 may be any type of device for storing application data as well as other data related to the described operation. The application data and other data are received by the processor 310 for configuring the processor 310 to perform operation acts in accordance with the present system. The operation acts may include operation in profile selection, advertiser/content selection and controlling the display 330 to display content such as the virtual environment and related operation paradigms (e.g., user interface). The user input 370 may include a keyboard, mouse, trackball or other device, including touch sensitive displays, which may be stand alone or be a part of a system, such as part of a personal computer, personal digital assistant, mobile phone, set top box or other device for communicating with the processor 310 via any operable link. The user input device 370 may be operable for interacting with the processor 310 including enabling interaction within virtual environment and/or other elements of the present system. Clearly the processor 310, the memory 320, display 330 and/or user input device 370 may all or partly be a portion of a computer system or other device such as a client and/or server as described above.

The methods of the present system are particularly suited to be carried out by a computer software program, such program containing modules corresponding to one or more of the individual steps or acts described and/or envisioned by the present system. Such program may of course be embodied in a computer-readable medium, such as an integrated chip, a peripheral device or memory, such as the memory 320 or other memory coupled to the processor 310.

The computer-readable medium and/or memory may be any recordable medium (e.g., RAM, ROM, removable memory, CD-ROM, hard drive, DVD, floppy disks and/or memory cards) or may be a transmission medium (e.g., a network comprising fiber-optics, the world-wide web, cables, or a wireless channel using time-division multiple access, code-division multiple access, and/or other radio-frequency channel). Any medium known or developed, or combination thereof, that can store and/or transmit information suitable for use with a computer system may be used as the computer-readable medium and/or memory.

Additional memories may also be used. The memory may be long-term, short-term, or a combination of long-term and short-term memories. These memories configure the processor 310 to implement the methods, operational acts, and functions disclosed herein. The memories may be distributed, for example between the clients and/or servers, or local, and the processor 310, where additional processors may be provided, may also be distributed or may be singular. The memories may be implemented as electrical, magnetic or optical memory, or any combination of these or other types of storage devices. Moreover, the term “memory” should be construed broadly enough to encompass any information able to be read from or written to an address in an addressable space accessible by the processor 310. With this definition, information accessible through a network is still within the memory, for instance, because the processor 310 may retrieve the information from the network for operation in accordance with the present system.

The processor 310 is operable for providing control signals and/or performing operations in response to input signals from the user input device 370 as well as in response to other devices of a network and executing instructions stored in the memory 320. The processor 310 may be an application-specific or general-use integrated circuit(s). Further, the processor 310 may be a dedicated processor for performing in accordance with the present system or may be a general-purpose processor wherein only one of many functions operates for performing in accordance with the present system. The processor 310 may operate utilizing a program portion, multiple program segments, or may be a hardware device utilizing a dedicated or multi-purpose integrated circuit.

Further use a variations of the present system would readily occur to a person of ordinary skill in the art and are encompassed by the following claims.

For example, the present system and/or devices may be readily applied to a social networking environment, such as Second Life™. Second Life is a social network not a gaming environment, yet operation in accordance with the present system may be readily achieved by controlling an avatars location and/or product/object location within the Second Life virtual world. In accordance with an embodiment of the present system, a user's avatar within the Second Life world may wander around the world utilizing a camera view (e.g., 3rd person view) or first person view. In accordance with the present system, objects and/or areas encountered by the user's avatar may be controlled. For example, Second Life supports a creation of a direct link to any place within the virtual environment through use of a so-called “SLurl”. Determination of the SLurl may be made in accordance with an embodiment of the present system. The SLurl may be provided at a time of logging into the Second Life world or may be provided at some time later when the user's avatar is wandering around. In accordance with a further embodiment, the SLurl may be tied to a product/object drop zone.

In a further embodiment, a set-top box based client may support the present system. In a further embodiment, the set-top box client may support a virtual shopping channel and/or television show, wherein selection of a particular channel or show is determined in accordance with the present system.

A given advertiser may host an area within the virtual environment with many brand areas. A user profiled to have an interest may be dropped into a particular portion of the area. The area may further support a purchase, such as a direct or third-party purchase of a product depicted in the virtual environment. In a further embodiment, interaction with the advertiser may be supported, such as through a chat-session to further enable providing information or a purchase. In accordance with an embodiment of the present system, support may be provided for a flash or applet based client launched from a browser. A person profiled to be ready to buy or be interested in a given product, may be “dropped” in an area of a competing product and/or advertiser. A provider of the present system may be enabled to charge the advertiser a premium for this client drop since an opportunity is provided to “steal” a competitor's potential buyer.

As may be readily appreciated, the present system is applicable to numerous variations on the system illustratively described. Variations on themes and pricing schedules would also readily occur to a person of ordinary skill in the art and are encompassed by the present system. In addition, any one of the above embodiments or processes may be combined with one or more other embodiments and/or processes or be separated and/or performed amongst separate devices or device portions in accordance with the present system. In other embodiment, portions of the present system may be provided/supported by other portions of the system or may be eliminated altogether. For example, the client proxy may be eliminated altogether in an embodiment wherein direct login of the user/user device is supported.

Finally, the above-discussion is intended to be merely illustrative of the present system and should not be construed as limiting the appended claims to any particular embodiment or group of embodiments. Thus, while the present system has been described with reference to exemplary embodiments, it should also be appreciated that numerous modifications and alternative embodiments may be devised by those having ordinary skill in the art without departing from the broader and intended spirit and scope of the present system as set forth in the claims that follow. In addition, the section headings included herein are intended to facilitate a review but are not intended to limit the scope of the present system. Accordingly, the specification and drawings are to be regarded in an illustrative manner and are not intended to limit the scope of the appended claims.

In interpreting the appended claims, it should be understood that:

a) the word “comprising” does not exclude the presence of other elements or acts than those listed in a given claim;

b) the word “a” or “an” preceding an element does not exclude the presence of a plurality of such elements;

c) any reference signs in the claims do not limit their scope;

d) several “means” may be represented by the same item or hardware or software implemented structure or function;

e) any of the disclosed elements may be comprised of hardware portions (e.g., including discrete and integrated electronic circuitry), software portions (e.g., computer programming), and any combination thereof;

f) hardware portions may be comprised of one or both of analog and digital portions;

g) any of the disclosed devices or portions thereof may be combined together or separated into further portions unless specifically stated otherwise;

h) no specific sequence of acts or steps is intended to be required unless specifically indicated; and

i) the term “plurality of” an element includes two or more of the claimed element, and does not imply any particular range of number of elements; that is, a plurality of elements may be as few as two elements, and may include an immeasurable number of elements.

What is claimed is:

1. A method of providing a landing zone in a virtual environment, the method comprising act of:
accessing a network by providing a user identifier;
retrieving a user profile based on the user identifier;
determining the landing zone based on the retrieved user profile; and
rendering the virtual environment based on the determined landing zone.

2. The method of claim 1, wherein the act of rendering the virtual environment comprises an act of initiating rendering of a user avatar at the landing zone.

3. The method of claim 2, wherein the landing zone is an advertiser sponsored area within the virtual environment and wherein the landing zone is related to one or more of advertiser products and trademarks.

4. The method of claim 1, wherein the act of rendering the virtual environment comprises an act of initiating rendering of an advertiser related object at the landing zone, wherein the advertiser related object is selected based on the retrieved user profile.

5. The method of claim 1, wherein the act of rendering the virtual environment comprises an act of initiating a login of a user on a server device hosting the virtual environment.

6. The method of claim 1, comprising an act of verifying authorization for a user corresponding to the user identifier to access the virtual environment.

7. The method of claim 6, wherein the act of verifying authorization for the user comprises an act of a service provider receiving compensation from an advertiser for providing the authorization and determined landing zone.

8. The method of claim 7, wherein the act of the service provider receiving compensation from the advertiser comprises an act of receiving increased compensation for providing a user associated with the user profile wherein the user profile contains elements indicating a bias towards one or more of the advertiser, products related to the advertiser and a trademark related to the advertiser.

9. The method of claim 1, wherein the act of rendering the virtual environment comprises an act of providing login credentials to a client proxy for the virtual environment.

10. The method of claim 1, wherein the act of rendering the virtual environment comprises an act of providing streaming content to a user device for rendering.

11. The method of claim 1, wherein the landing zone is determined from a plurality of potential landing zones associated with one or more advertisers.

12. The method of claim 1, wherein the user profile includes at least one of an explicit and implicit user profile.

13. A method of receiving advertiser compensation for providing user access to a landing zone within a virtual environment, the method comprising acts of:
maintaining a count of users provided to an advertiser's landing zone;
providing the count of users to an advertiser related to the advertiser's landing zone; and
receiving compensation from the advertiser based on the count.

14. The method of claim 13, comprising acts of:
receiving a user request for access to the virtual environment; and
retrieving a profile associated with the user.

15. The method of claim 13, wherein the advertiser's landing zone is an advertiser sponsored area within the virtual environment and wherein the advertiser's landing zone is related to one or more of advertiser products and trademarks.

16. The method of claim 13, wherein the advertiser's landing zone is a location within the virtual environment wherein an advertiser related object is rendered and wherein the advertiser related object is selected based on a retrieved user profile.

17. The method of claim 13, comprising an act of verifying authorization for a user corresponding to one of the count of users to access the virtual environment.

18. The method of claim 17, wherein the act of verifying authorization for the user comprises an act of a service provider receiving compensation from an advertiser for providing the authorization and advertiser's landing zone.

19. An application embodied on a computer readable medium arranged to coordinate advertiser compensation for providing user access to a landing zone within a virtual environment, the application comprising:
a portion configured to maintain a count of users provided to an advertiser's landing zone;
a portion configured to provide the count of users to an advertiser related to the advertiser's landing zone; and
a portion configured to receive compensation from the advertiser based on the count.

20. The application of claim 19, comprising:
a portion configured to receive a user request for access to the virtual environment; and
a portion configured to retrieve a profile associated with the user.

21. The application of claim 19, wherein the advertiser's landing zone is an advertiser sponsored area within the virtual environment and wherein the advertiser's landing zone is related to one or more of advertiser products and trademarks.

22. The application of claim 19, wherein the advertiser's landing zone is a location within the virtual environment wherein an advertiser related object is rendered, the application comprising a portion configured to select the advertiser related object based on a retrieved user profile.

23. The application of claim 19, comprising a portion configured to verify authorization for a user corresponding to one of the count of users to access the virtual environment.

24. The application of claim 23, wherein the portion configured to verify authorization for the user comprises a portion configured to receive compensation from an advertiser for providing the authorization and advertiser's landing zone.
